(19) United States
(12) Patent Application Publication
(10) Pub. No.: US 2005/0198559 A1
(43) Pub. Date: Sep. 8, 2005

(54) Document information management system, document information management program, and document information management method

(75) Inventor: Akihiko Fujiwara, Yokohama-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/793,894

(22) Filed: Mar. 8, 2004

(51) Int. Cl. G06F 7/00

(52) U.S. Cl. 715/500

(57) ABSTRACT

A document information management device or the like is obtained which is capable of effectively performing search for documents by utilizing attribute-related information for document information management. The device includes a document information management device for managing document information, which comprises a document-related information management section that analyzes, acquires and manages relevance information between documents as the document information, and an attribute-related information management section that analyzes, acquires and manages relevance information between attributes of the documents as the document information.

### BACKGROUND OF THE INVENTION

1. Field of the Invention

The present invention relates to a document information management device, a document information management program and a document information management method for managing document information such as text files of applications, data files with formats such as image, audio, etc.

2. Description of the Related Art

In conventionally known document information management devices, when information of a document is managed, attribute information carried by the document is managed together with the document information thereof. Such attribute information includes property information such as, for example, the author or creator of the document, the group to which the creator belongs, the place in which the creator is mainly resident, users of the document, the group or groups to which the users belong, the place or places in which the users are mainly resident, the data and time of creation, the weather at the time of creation, the environment around the creator at the time of creation, the dates and times of use, the weathers at the time of use, the environments around the users, the applications used for creation, etc. Referring to a system in which by utilizing such attribute information, for example, information of a document is managed together with information on a creator who created the document as its attribute information, it is possible to improve the convenience and easiness of the management of the document information by separately keeping or storing information for entire users who can make use of the system in certain forms such as a user table in a database, and by giving consistency between actual users and those in the user table through cross reference.

However, when the amount of documents managed by such a document information management system or device increases, a means for finding desired documents is needed. In such a case, the management device helps users looking for documents by providing the following functions.

(1) Storage folders and categories can be set for documents to be stored, so that the documents can be properly organized by using such a management structure.

(2) An appropriate search such as a full-text search, etc., is made according to the contents of documents to be searched.

(3) Documents are sorted through a user view capable of displaying a list of the documents by making use of their attribute information.

These functions (1) through (3) can be used individually but also in any combination thereof as stated below. Specifically, a full-text search is performed with respect to a specific folder and its lower layers (i.e., subfolders) alone by using the above functions (1) and (2) in combination. A list of documents in the specific folder is sorted in the order of creators by using the above functions (1) and (3) in combination. A list of documents obtained as a result of the full-text search is sorted sequentially in the order of the date of creation from the new to the old by using the above functions (2) and (3) in combination.

Thus, in the case of making use of attribute information in such a document information management device, it is possible to determine an importance of each document in a manner closer to the use sense of a user. For example, in a web search system according to U.S. Pat. No. 6,285,999B1, link conditions between pages are extracted as relevance information between the pages from the contents of collected web pages, and reference or citation relevance is analyzed therefrom to rank the pages of high importance. Then, by arranging the pages searched through a keyword search in the order of their importance from the highest to the lowest, it is possible to provide, in response to the dissemination of information from a user, documents in the order which seem to be more important to the user (i.e., web pages in this case). Here, note that this is known as a page ranking technique, and used in a well-known search site, Google (registered trademark).

In the above-mentioned U.S. Pat. No. 6,285,999B1 (page ranking technique), however, when the importance of pages is ranked, the link conditions in the form of attribute information between the pages are used, but other information, i.e., attribute-related information which is information related to the attribute information of the pages, is not utilized.

The attribute-related information includes, according to its characteristics, what gives a clue in the determination of the importance, and by using the attribute-related information upon the ranking of importance, it is possible to obtain an appropriate importance corresponding to the purpose that the user wants such as a search purpose, etc.

Therefore, there has been demanded that a document search should be able to be carried out in an effective manner by making use of such attribute-related information for the management of document information.

### SUMMARY OF THE INVENTION

The present invention is intended to obviate the problems as referred to above, and has its object to provide a document information management device, a document information management program and a document information management method which can perform the ranking of the importance of documents that a user needs for example, by making use of attribute-related information of the documents, so that a search can be carried out in an efficient manner.

In order to achieve this object, the present invention resides in a document information management device for managing document information, which comprises: a document-related information management section that analyzes, acquires and manages relevance information between documents as the document information; and an attribute-related information management section that analyzes, acquires and manages relevance information between attributes of the documents as the document information.

In this case, the document-related information management section can be constructed such that it acquires a document operating condition, and analyzes and acquires document-related information based on the document operating condition. Also, the attribute-related information management section can constructed such that it analyzes and acquires the attribute-related information based on the document-related information acquired by the document-related information management section.

Further, the attribute-related information management section can be constructed such that it includes a relevance-strength time-related change setting section that is able to variably set the strength of attribute relevance in the acquired attribute-related information in a time-related manner.

Moreover, provision can be made for a first attribute-related information setting section that presents a predetermined attribute to a user for setting so as to permit the user to set attribute relevance which is to be managed by the attribute-related information management section. Alternatively, provision can be made for a second attribute-related information setting section that accesses an outside attribute management section managing attributes through a communication line to acquire an attribute, and sets the attribute relevance managed by the attribute-related information management section into the attribute-related information management section based on the attribute thus acquired.

In addition, provision can be made for a relevance information search section that searches for other attributes related to a prescribed attribute by using the prescribed attribute as a key.

In another aspect, the present invention resides in a document information management device for managing document information, which comprises: a document-related information management section that analyzes, acquires and manages relevance information between documents as the document information; an attribute-related information management section that analyzes, acquires and manages relevance information between attributes of documents as the document information; and an order decision section that decides the order of presentation of searched documents by using at least either one of the document-related information and the attribute-related information.

In this case, when deciding the order of presentation of searched documents by using the attribute-related information, the order decision section calculates an importance of each attribute value based on a plurality of pieces of attribute-related information and decides the order of the documents by using the importance values thus calculated.

In a further aspect, the present invention resides in a document information management program for making a computer execute document information management to manage document information, the document information management program being adapted to make the computer perform: a document-related information acquisition step for analyzing and acquiring relevance information between documents as the document information; and an attribute-related information acquisition step for analyzing and acquiring relevance information between attributes of the documents as the document information.

Here, in the document-related information acquisition step, the computer is made to acquire a document operating condition, and analyze and acquire document-related information based on the document operating condition. In addition, in the attribute-related information acquisition step, the computer is made to analyze and acquire the attribute-related information based on the document-related information acquired in the document-related information acquisition step. Moreover, the document information management program can further include a time-related change setting step which is executed by the computer to be able to variably set the strength of attribute relevance acquired in the attribute-related information acquisition step in a time-related manner.

Further, the attribute-related information acquisition step can include a step that is executed by the computer to present a prescribed attribute to a user so as to permit a user to set attribute-related information to be acquired.

Furthermore, the attribute-related information acquisition step includes a step that is executed by the computer to make access to an outside attribute management section managing attributes through a communication line to acquire an attribute, so that the attribute-related information is acquired based on the attribute thus acquired.

Still further, the attribute-related information acquisition step can include a step that is executed by the computer to search for other attributes related to a prescribed attribute by using the prescribed attribute as a key.

In a yet further aspect, the present invention resides in a document information management program for making a computer execute document information management to manage document information, the document information management program being adapted to make the computer execute: a document-related information acquisition step in which relevance information between documents is analyzed and acquired as the document information; an attribute-related information acquisition step in which relevance information between attributes of the documents is analyzed and acquired as the document information; and an order decision step in which the order of presentation of searched documents is decided by using at least either one of the document-related information and the attribute-related information.

Here, the order decision step includes a step that is executed by the computer to calculate an importance of each attribute value based on a plurality of pieces of attribute-related information when the order of presentation of searched documents is decided by using the attribute-related information, so that the order of the documents is decided by using the importance values thus calculated.

In a still further aspect, the present invention resides in a document information management method for managing document information, which comprises: an operating condition acquisition step for acquiring a document operating condition; a document-related information acquisition step for analyzing and acquiring relevance information between documents as the document information from the document operating condition; and an attribute-related information acquisition step for analyzing and acquiring relevance information between attributes of the documents by using the relevance information between documents.

Here, the document information management method can further comprises an order decision step for deciding the order of presentation of searched documents by using at least either one of the relevance information between documents and the relevance information between attributes of the documents are.

### DESCRIPTION OF THE DRAWINGS

FIG. 1 is a block diagram showing an overall basic configuration of a document information management system according to one embodiment of the present invention.

FIG. 2 shows a document operation record table.

FIG. 3 relates to an Acquisition of Attribute-Related Information (Example 1), showing a flow chart of one example of an operation to analyze and acquire attribute-related information from the document operation record table of FIG. 2.

FIG. 4 is a document-related information table.

FIG. 5 is a view showing the association of attributes of applications in the form of an attribute-related information table, representing the relevance or relation between referenced applications and referencing applications that make reference to the referenced applications.

FIG. 6 relates to an Acquisition of Attribute-Related Information (Example 2), showing a flow chart of one example of an operation to manage attribute-related information whose strength of relation changes over time.

FIG. 7 is a table of attribute-related information in the form of user-related information.

FIG. 8 is a table showing the result of the processing of reducing “the strength of relation” by half.

FIG. 9 is a table in which the date and time searched from the table shown in FIG. 7 are set as “the date and time at which the relation was last observed”.

FIG. 10 is a block diagram showing an example of the configuration of a device and a system associated with an Acquisition of Attribute-Related Information (Example 3).

FIG. 11 is a flow chart showing one example of an operation in the Acquisition of Attribute-Related Information (Example 3).

FIG. 12 is an attribute-related information table showing the relevance or relation instructed from an attribute relation setting section.

FIG. 13 is a block diagram of a device and a system associated with an Acquisition of Attribute-Related Information (Example 4).

FIG. 14 is a flow chart showing one example of an operation in an Acquisition of Attribute-Related Information (Example 4).

FIG. 15 is a table showing the attribute-related information transmitted from an attribute relation setting section.

FIG. 16 is a block diagram showing the configuration of the device or system shown in FIG. 1, but further including a relevance information search section.

FIG. 17 is a flow chart showing a search operation by the relevance information search section.

FIG. 18 is a block diagram showing a document information management device capable of ranking important ones from among the documents to be managed.

FIG. 19 is a flow chart showing a ranking operation.

FIG. 20 is a view showing one example of the relevance or relation between referenced documents and documents derived from the referenced documents.

FIG. 21 is a block diagram in the case where an information search section capable of performing information search is added to the document information management device capable of performing ranking as explained in FIG. 18.

### DESCRIPTION OF THE PREFERRED EMBODIMENT

<Basic Structure>

Now, a preferred embodiment of the present invention will be described below in detail while referring to the accompanying drawings.

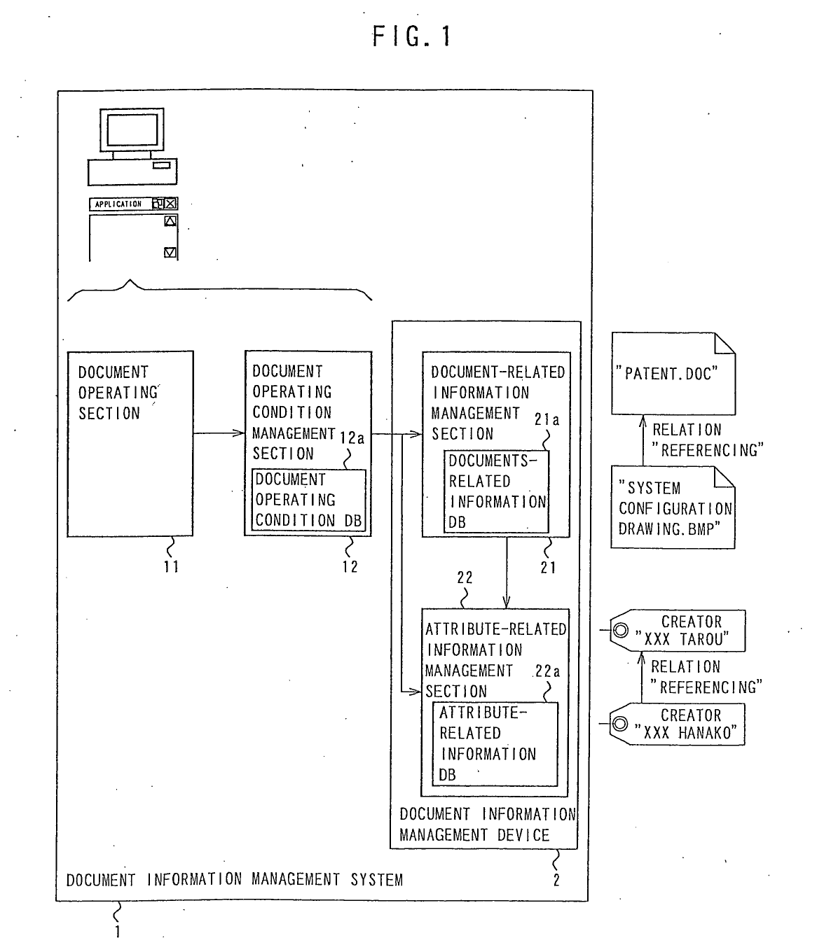

FIG. 1 is a block diagram that shows the overall configuration of a document information management device and system according to one embodiment of the present invention.

This document information management system 1 includes a document operating section 11 that can be constituted by, for instance, a personal computer (PC) which is at a client side and which can perform, by activation of an application or applications, various operations such as creation, editing, changing, etc., of documents, and a document operating condition management section 12 that monitors the operating condition of the document operating section 11 by monitoring the activation of applications for instance, and acquires and manages it as records.

Also, the document information management system 1 further includes a document-related information management section 21 that is constituted by the same PC as a part of a document information management device 2 built into this system, or that can be constituted by another information processing device such as a PC, a server device, a multifunction peripheral (MFP), etc., and that acquires the document operating condition managed by the document operating condition management section 12, and acquires and manages document-related information by analyzing relevance or relation information between documents in the form of document relation from the document operating condition thus obtained, and an attribute-related information management section 22 that acquires the information managed by at least either one of the document operating condition management section 12 and the document-related information management section 21, and manages, based on that information, attribute-related information which is the information related to the attributes of the documents.

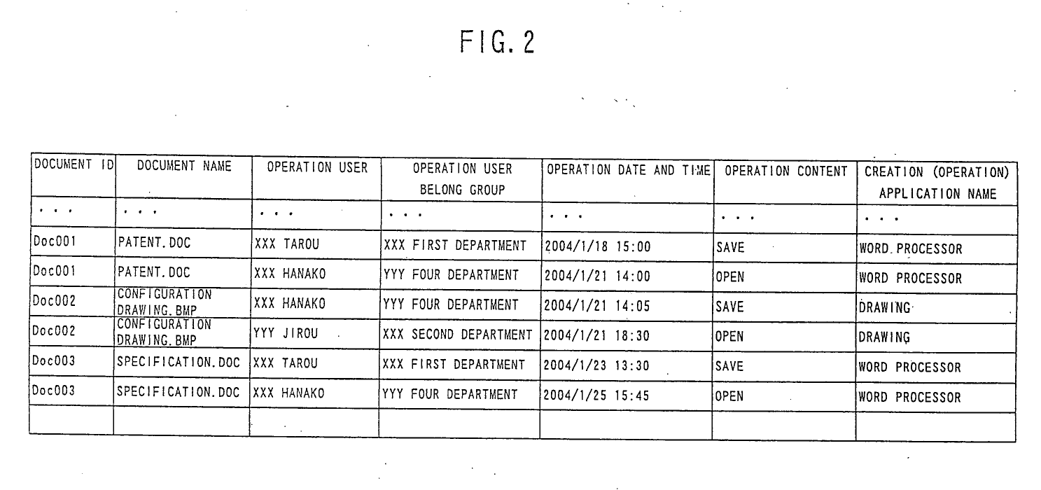

One example of the operating condition managed by the document operating condition management section 12 is illustrated in a document operation record table of FIG. 2. According to this table, document ID, document name, operation user, operation user group, operation date and time, operation content, and creation (operation) application name are managed as operation history or records (operating condition).

The document-related information management section 21, though will be explained in detail later, analyzes, extracts and manages document relevance or relation as the relevance or relation between documents at the time of document operations, for example, when certain documents are “referenced” in operations of other documents or when certain documents are “derived” from other documents in operations thereof, etc. For example, it manages information on the relevance or relation of a document (e.g., A “patent.doc” was cited or referenced when a “system configuration drawing.bmp” was created, etc.).

In addition, the attribute-related information management section 22, though will also be explained in detail later, analyzes, extracts and manages relevance or relation between attributes possessed by documents such as, for example, “a case where a certain attribute is referenced”, “a case where certain attribute is derived”, etc. For example, it manages information related to an attribute “creator” (e.g., A creation or document of Mr. “XXX Tarou” was referenced when Ms. “XXX Hanako” made some creation, etc.).

Here, note that in the above configuration, the document operating condition management section 12, the document-related information management section 21, and the attribute-related information management section 22 can be constituted by software modules, respectively. In addition, the document operating condition management section 12 is provided with a document operating condition database (DB) 12a that stores document operating conditions (e.g., a document operating condition record table), and the document-related information management section 21 is provided with a document-related information database (DB) 21a that stores document-related information, and the attribute-related information management section 22 is provided with a database (DB) 22a that stores attribute-related information.

### ACQUISITION OF ATTRIBUTE-RELATED INFORMATION (EXAMPLE 1)

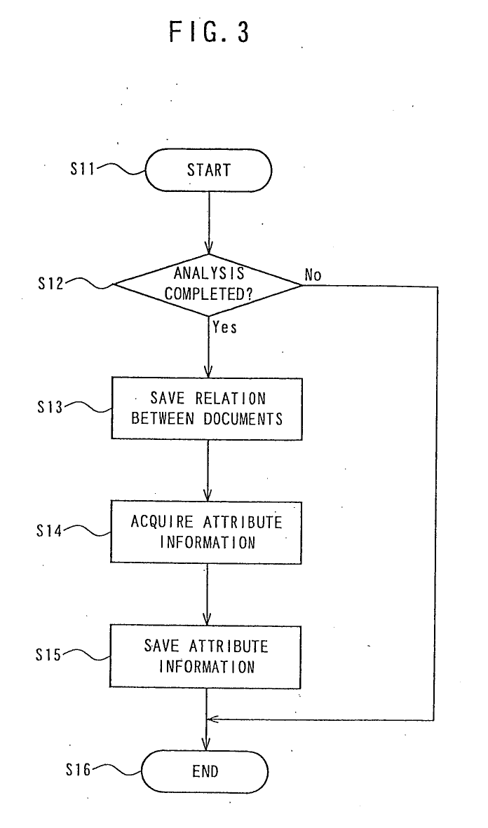

Here, reference will be made to one example in which in the device configuration of FIG. 1, attribute-related information is analyzed and acquired from a document operation record table of FIG. 2, in accordance with a flow chart of FIG. 3. Here, document-related information, which is relevance or relation information between documents, is first acquired, and attribute-related information is then acquired based on the document-related information thus obtained. In this connection, note that the above and following operations, being hereinafter described based on the flow chart of FIG. 3, are performed by programs that are stored in a memory and executed by a computer in the document information management device.

(Step S11: Start)

At the start of step S11, the document operation record table of FIG. 2 is acquired by the document-related information management section 21, and an analysis of the relevance or relation between documents (relation extraction) is started.

(Step S12: Analysis Completed?)

In step S12, a determination is made as to whether the analysis on the relation between the documents has been performed, and if performed (Yes), the control process or processing proceeds to step S13 whereas if not performed (No), it is determined that there is no relevance or relation between the documents, and the control flow proceeds to step S16 where this processing is completed.

(Step S13: Save of the Relation Between Documents)

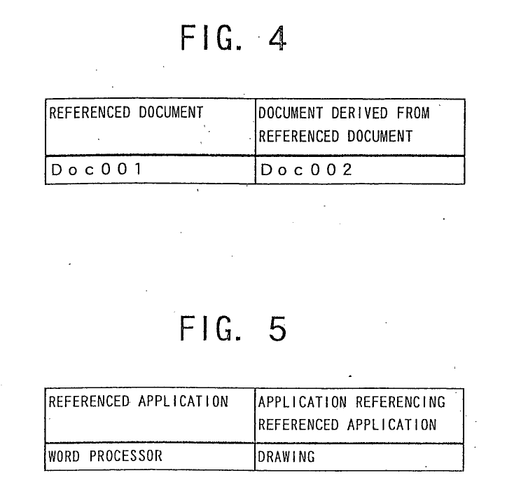

When the relation between documents has been analyzed in step S12, then in step S13, the relation obtained as a result of the analysis is written into the document-related information table as document-related information, as shown in FIG. 4, and stored in the document-related information database 21a.

(Step S14: Acquisition of Attribute Information)

In step S14, attribute information corresponding to each of the mutually relevant or related documents obtained in step S13 is acquired. In documents Doc001 and Doc002, which are mutually related to each other as shown in FIG. 4, the document Doc001 (“patent.doc”) is operated or manipulated (created) by a software or application “Word Processor”, and the document Doc002 (“configuration drawing.bmp”) is operated (created) by a software or application “Drawing)”. Those pieces of information are kept or stored in the document operating condition database as like “creation applications” in FIG. 2, so that the attribute-related information management section 22 acquires those pieces of data as attribute information.

(Step S15: Save of Attribute Information)

In step S15, the pieces of attribute information acquired in step S14 are related or associated with one another in a manner as shown in FIG. 5 to form an attribute-related information table, which is then stored in the attribute-related information database 22a. Here, note that in FIG. 5, the attributes are associated with one another by the relevance or relation between referenced applications and referencing applications which made reference to the referenced applications.

(Step S16: Completion)

The acquisition processing of the attribute-related information is completed by acquiring the attribute-related information, and saving it in the database.

In the acquisition and management of the attribute-related information as referred to above, processing is performed such that the documents whose mutual relation is extracted by the processing of analyzing document relation at regular intervals are considered to have similar relation with respect to their attributes, and the result of such processing is acquired, saved and managed as attribute-related information by means of the attribute-related information management section 22. Since this processing can be carried out by merely adding to the conventional processing of extracting document relation the processing of extracting and associating attributes of documents as being considered to have relevance or relation to the values of their attributes, it is possible to manage the attribute-related information along with the document-related information without increasing operation time to much extent in comparison with the prior art.

### ACQUISITION OF ATTRIBUTE-RELATED INFORMATION (EXAMPLE 2)

According to the attribute-related information in the Acquisition of Attribute-Related Information (Example 1) as mentioned above, there can be known or found a tendency of relevance or relation in the working environment such as “When a document is created by an application “Drawing”, documents created by an application “Word Processor” is often referenced”.

On the other hand, there is a demand that the tendency of the relations between users should be able to be known from the access history or records of documents. The access tendency of the users has a characteristic that the relation between users is fluidic and changes with the passage of time.

For example, there is a case where Mr. “XXX Tarou” and Ms. “YYY Hanako” once belonged to the same project at a certain time, so they mutually made frequent access to the documents that were created by them, but after the project was completed, the frequency of their accesses to the documents substantially decreases to zero, thus reducing or thinning their relation.

In the case of attributes related to those users who have such a characteristic (e.g., “Creators (or Authors)” and “Referencing Persons”), simply considering, based on the relevance or relation between the documents, that there exists a similar relation between their attributes (“Creators” and “Referencing Persons”) may sometimes become inaccurate depending upon the time.

Accordingly, for such attributes, it is necessary to employ a technique of extracting the relevance or relation of the attributes separately from the relevance or relation of the documents. Alternatively, in some cases, it is necessary to extract and manage the relevance or relation between values of a plurality of different attributes.

Here, reference will be made to the case where a relation between attributes (“Creators” and “Referencing Persons”) is extracted by making use of the document operation history or records accumulated in the document operating condition database.

Based on the history or records of the document operating conditions accumulated in the document operating condition database, it is possible to observe or inspect the sequence of access records such as which referencing persons accessed documents of which creators, and to extract such information. Based on the information thus extracted, the attribute-related information management section 22 determines that a certain referencing person and the creator of a document which was referenced by the referencing person have a relevance or relation of reference between the referencing person and the creator through the referencing of the document. In addition, the strength of the relevance or relation increases whenever a similar sequence is observed from the access history.

On the other hand, when the access records between the referencing person and the creator have not been observed (i.e., the documents created by the creator have not been accessed by the referencing person) for a prescribed period of time, the strength of the relevance or relation therebetween decreases. Here, there is adopted the following method of simulating the strength of the relation between these attributes. That is, when three days have passed since no access record was observed (i.e., from the last time a document of the creator was referenced by the referencing person), the value of the strength of the relation decreases to half, and when a week has further passed thereafter, the strength of the relation further decreases to half.

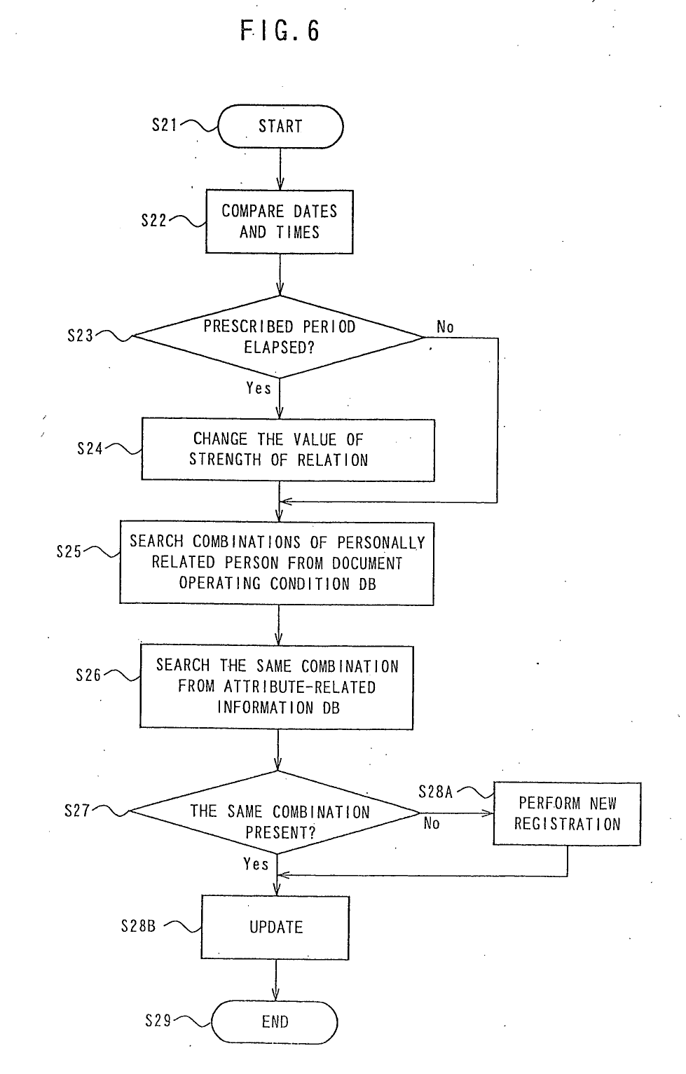

Hereinafter, reference will be made to one example of the management of the attribute-related information whose strength of relation changes with the passage of time (update processing of the user-related information table), according to a flow chart of FIG. 6.

(Step S21: Start)

In step S21, the processing of analyzing the relation between persons (e.g., the relation between “referencing persons” and “creators”) as the relevance or relation between attributes of documents is started.

(Step S22: Comparison of Dates and Times)

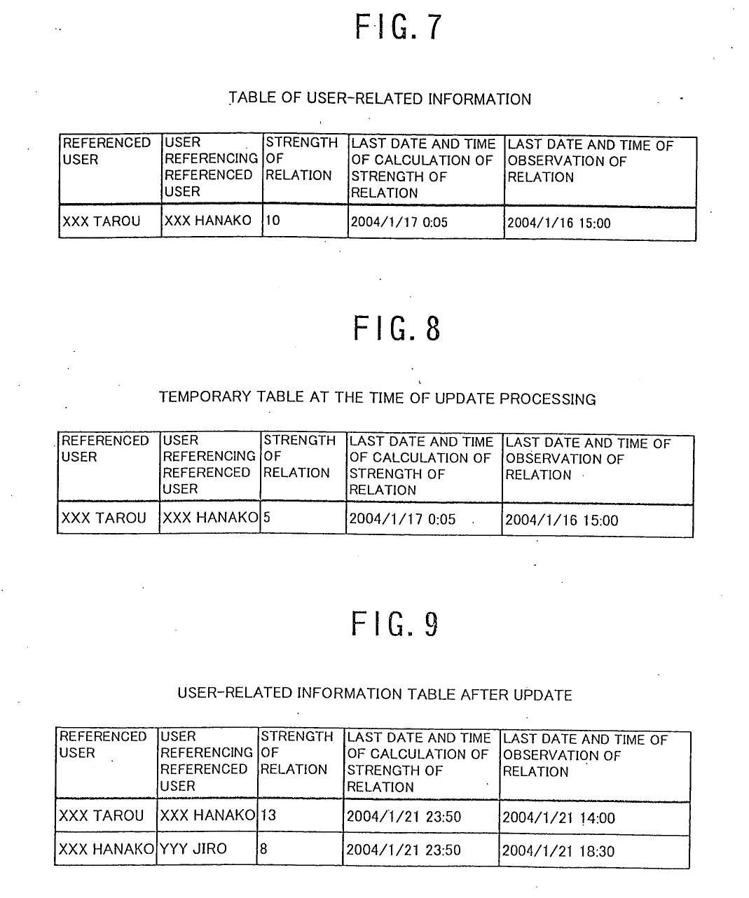

In step S22, the attribute-related information management section 22 extracts, from the attribute-related information database 22a, a table of attribute-related information in the form of user-related information as shown in FIG. 7, and makes a comparison between “the last day and time at which the strength of relation was last calculated” and the current date and time. The table in FIG. 7 shows the relevance or relation of the users which had already been analyzed (extracted) before the records of the document operating conditions shown in FIG. 2 were recorded.

(Step S23: Determination Whether a Prescribed Time has Passed)

First of all, let us assume that the current time at which updating is being performed is 23:50, Jan. 21, 2004. The attribute-related information management section 22 first checks “the last relevance or relation strength calculation dates and times” for all the records in the table shown in FIG. 7, and determines, based on comparisons of them with the current date and time, whether a prescribed period of time (e.g., 3 days) has passed. When the prescribed time has passed, the control flow proceeds to step S24 whereas when otherwise, the control flow proceeds to step S25 while skipping step S24.

(Step S24: Changing of the Value of the Strength of Relation)

When it is determined in step S23 that the prescribed time has passed, “the strength of relation” in the table is changed to decrease. Here, the processing of decreasing the strength of relation to half is performed, and a table representing the result of this processing is illustrated in FIG. 8.

(Step S25: Search for Combinations of Related Persons from the Document Operating Condition DB)

In step S25, a check is made as to the information that has been recorded (saved) in the document operating condition database after the last check. Since the last check was made at 0:05, Jan. 17, 2004, as shown in FIG. 7, the records after that time until the current time become the target to be searched. Ms. “XXX Hanako” opened a “patent.doc” that was created by Mr. “XXX Tarou”, so a pair or combination of a referencing person “XXX Hanako” and a referenced person “XXX Tarou” is recognized as a relation therebetween. Also, Mr. “YYY Jirou” opened a “configuration drawing.bmp” that was created by Ms. “XXX Hanako”, so a pair or combination of a referencing person “YYY Jirou” and a referenced person “XXX Hanako” is recognized as a relation therebetween.

(Step S26: Search for the Same Combination from the Attribute-Related Information DB)

Then, the attribute-related information management section 22 looks for the records of the combination of Ms. “XXX Hanako” and Mr. “YYY Jirou” and of the combination of Mr. “XXX Tarou” and Ms. “XXX Hanako” from the table (attribute-related information table) shown in FIG. 8.

(Step S27, S28A and S28B: Processing in Case of the Absence of any Combination)

It is determined whether the combination of Ms. “XXX Hanako” and Mr. “YYY Jirou” is present. When this combination is not present in the table, the record of this combination is added as a new registration (S28A), and at the same time a prescribed value is set as “the strength of relation” for this combination (e.g., 8 is added here) (S28B).

(Steps S27 and S38B: Processing in the Case of the Presence of a Combination)

When the combination of Mr. “XXX Tarou” and Ms. “XXX Hanako” is already present in the table (e.g., “the strength of relation is 5”), the value of “the strength of relation” of this combination is increased (e.g., 8 is added here). In addition, since the respective strengths of relations in both of the combinations have been updated, the current date and time is set as “the last day and time of the calculation of the strength of relation”. Also, the date and time searched from the table shown in FIG. 7 is set as “the last date and time at which the relation was observed at the last time”. The table at this point in time is shown as an updated table in FIG. 9.

(Step S29: Completion)

The table obtained in step S27 is stored in the attribute-related information database 22a, and the processing is completed.

The above-mentioned processing of the Acquisition of Attribute-Related Information (Example 2) performs the technique of deriving more accurate relation according to the characteristics of attributes. Moreover, by performing the regular analysis of the document-related information management section 21 and the processing of deriving relation according to the characteristics of attributes by the attribute-related information management section 22 at matched or synchronized timing, processing such as, for example, one for reading out data from the document operating condition database 12a can be made common, thus making it is possible to reduce the time and resources required for the overall processing. In addition, it is possible to select a means for determining, from the relation of documents as shown in the Acquisition of Attribute-Related Information (Example 1), that the documents have a relation of their attributes, too, and/or a relation extraction means provided for attribute shaving other characteristics, so that an appropriate means to be applied or used can be selected in accordance with the device or the preferences of the user using the device.

### ACQUISITION OF ATTRIBUTE-RELATED INFORMATION (EXAMPLE 3)

In the Acquisition of Attribute-Related Information (Example 1) and the Acquisition of Attribute-Related Information (Example 2) as stated above, reference has been made to the technique of automatically extracting relations between attributes by means of the present devices, but it might be difficult to always obtain accurate relations between attributes depending upon circumstances. On the other hand, there are cases where the values that can be taken by attributes are limited and hence it might be reasonable for the user to acquire their relations by himself or herself, depending upon the attributes.

Accordingly, it is preferred that for such attributes, those values which can be taken by the attributes be elected and presented to the user by a device for prompting user's input of their relations, so that actual relevance or relation information can be input by the user at his or her own discretion.

One example of such a device is described below in this Acquisition of Attribute-Related Information (Example 3).

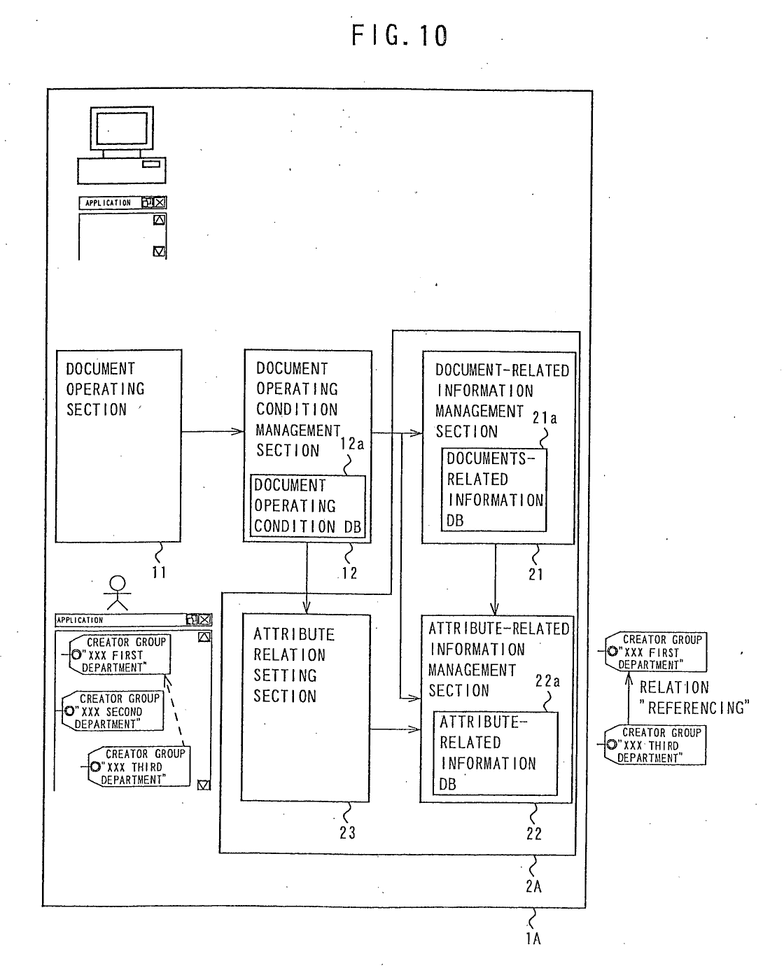

FIG. 10 is a block diagram that shows an example of the configuration of a device 2A and a system 1A associated with the Acquisition of Attribute-Related Information (Example 3). In this example, new provision is made for an attribute relation setting section 23 that serves to permit a user to input a relevance or relation between attributes to the document information management device 2 as shown in FIG. 1.

The attribute relation setting section 23 can acquire a list of attribute values from the document operation history or record table shown in FIG. 2 to present it to the user, and it is constituted, for instance, by a software module that provides the function of prompting the user to input a relation.

The attribute relation setting section 23 serves to extract information on attributes from the document operation records, recognize it as the values of the attributes, create a list of the values of the attributes thus recognized, and present it to the user, so that the user can carry out, from the list presented, appropriate setting for attribute values which the user considers have relevance.

Hereinafter, reference will be made to the case where an attribute is set for the relation or relevance of “groups to which creators or authors belong” for instance.

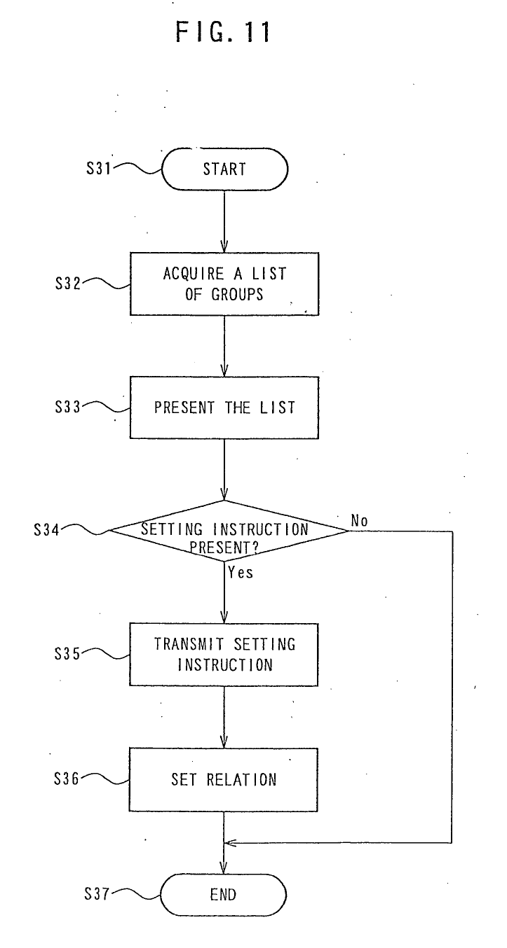

An example of the operation of the Acquisition of Attribute-Related Information (Example 3) will be described while using a flow chart of FIG. 11.

(Step S31: Start)

In step S31, the presentation and setting of relevance or relation between the attributes of documents (the relevance or relation between groups) are started.

(Step S32: Acquisition of a Group List)

The attribute relation setting section acquires a list of values existing in the column “Operation User Belonging Group” from the document operation record table shown in FIG. 2. Here, groups of “XXX First Department”, “XXX Second Department”, and “YYY Fourth Department” are acquired.

(Step S33: Presentation of the List)

Then, the list thus acquired is presented to the user so as to prompt the user with to provide a setting instruction.

Here, note that a relation “The “XXX First Department” is a group referenced by the “YYY Fourth Department”.” is set by using a setting application (I) that serves to enable the user to easily set an appropriate relation by arranging attribute values by illustration for example.

(Step S34: Determination of the Presence or Absence of a Setting Instruction)

It is determined whether there is present an instruction for setting a relation from a setting user.

(Step S35: Transmission of the Setting Instruction)

When it is determined that there is present a setting instruction, the attribute relation setting section 23 transmits the determination result and the content of the setting instruction to the attribute-related information management section 22.

(Step S36: Setting of a Relation)

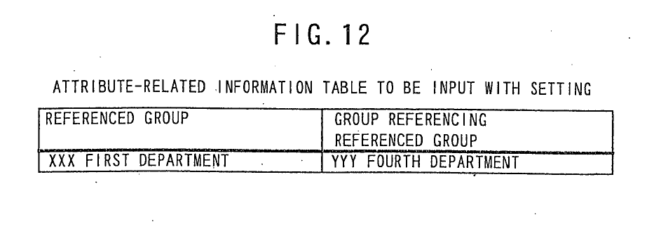

The attribute-related information management section 22 sets a relation instructed from the attribute relation setting section 23 into the attribute-related information database 22a as a table as shown in FIG. 12.

(Step S37: Completion)

The relation is registered in the attribute-related information database 22a, and the processing is completed. Here, note that when there is present no instruction in step S35, the processing is also completed.

Thus, according to this example, it is possible to perform a practical and efficient setting of attribute-related information.

### ACQUISITION OF ATTRIBUTE-RELATED INFORMATION (EXAMPLE 4)

The above-mentioned Acquisition of Attribute-Related Information (Example 3) has described the case where the user sets the values of attributes, but in this fourth example (Example 4), relation may be set by using the information that is managed in the outside of the system. In this example, reference will be made to the case where attribute relation can be set by using the information managed on the outside.

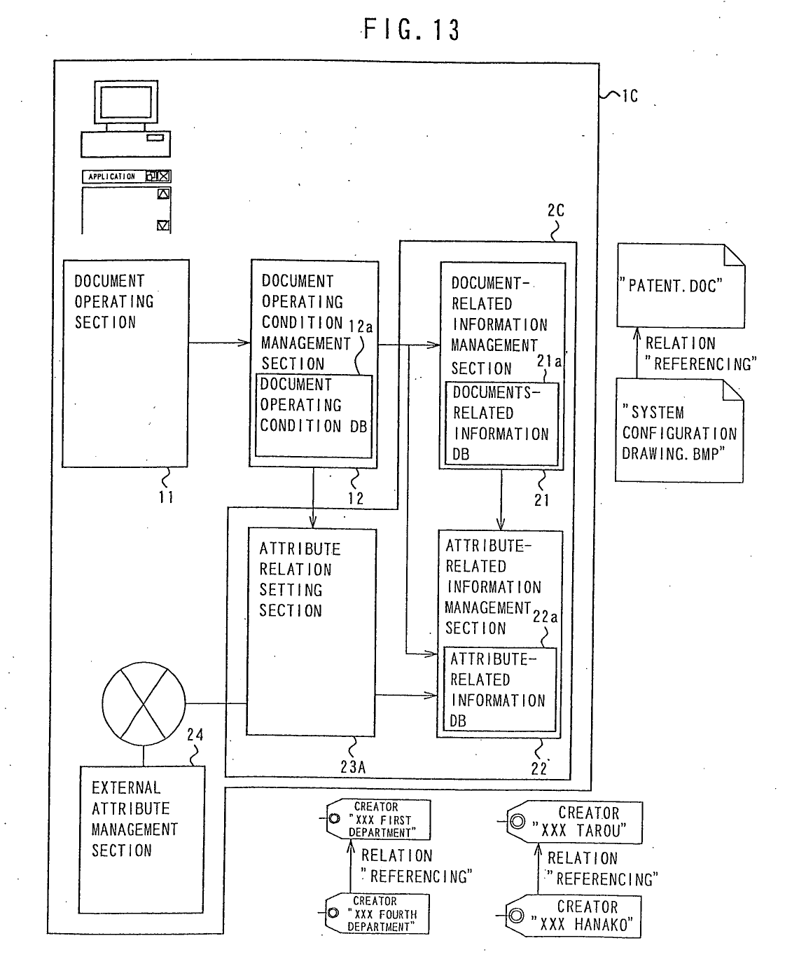

FIG. 13 is a block diagram of a device 2C and a system 1C associated with this Acquisition of Attribute-Related Information (Example 4). An attribute relation setting section 23A shown in FIG. 10 is further connected to an external attribute management section 24 arranged outside of this device through a network.

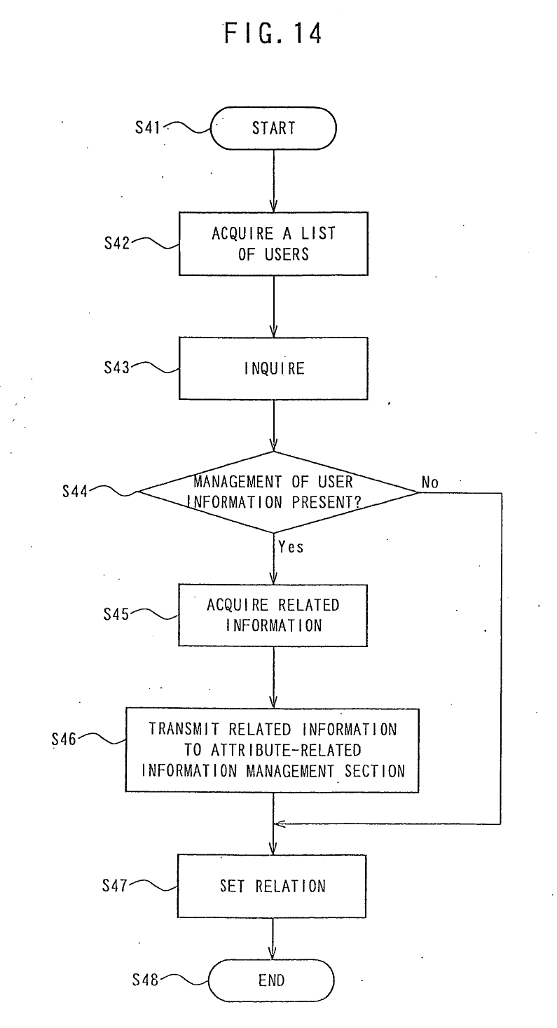

This external attribute management section 24 is not provided for the purpose of managing the relation of attribute information as originally intended by this device, but is utilized when the information managed by the external attribute management section 24 can be used as attribute information to be managed by this device. For example, a server, which describes or stores the meaning relation of component elements such as an LDAP server, an ontology management server, etc., which serve to manage user information and user's belonging group information and which can be inquired through a network, can be constituted as the external attribute management section 24. Hereinafter, the operation of this example will be described while using a flow chart shown in FIG. 14.

(Step S41: Start)

Here, reference will be made to an example of attribute relation setting in the case of inquiring attribute relation in the form of belonging relation in the user's organization (user's relation) such as, for example, relation between attributes (groups to which creators belong).

(Step S42: Acquisition of a User List)

The attribute relation setting section 23A extracts pieces of information on attributes from the document operation history or records stored in the document operating condition database 12a, and recognizes them as the values of the attributes. Here, pieces of information on the creators of documents stored in the document operating condition database 12a are extracted.

(Step S43: Inquiry)

The attribute relation setting section 23A creates a list of the attributes recognized as the values thereof, and makes inquiries of the attribute values thus listed to the external attribute management section 24 managing the attributes concerned. In the case of a plurality of external attribute management sections 24 being provided, as for which attributes are to be inquired to which external attribute management sections 24, what is generally published beforehand can be set for the entire system, or a user can set particular external attribute management sections 24 in accordance with the user's environment. In the former case, there are information providing servers which are published on the Internet and to which inquiries are made by using web services or the like, whereas in the latter case, there are user management databases of a groupware, etc., which are managed under a user-specific network environment.

Here, assuming that Mr. “XXX Tarou” and Ms. “XXX Hanako” were extracted in step S42, the attribute relation setting section 23A makes an inquiry of the relation between these attribute values to an external attribute management section in the form of an LDAP server.

(Step S44: Determination of the Presence or Absence of the Management of User Information)

The attribute relation setting section 23A determines whether the external attribute management section 24 manages inquiries. In the external attribute management section 24 in the form of an LDAP server, user's names, their belonging departments and the relation of dependence between the departments are managed. Here, the LDAP server manages, as information, the fact that Mr. “XXX Tarou” belongs to the “XXX First Department” and that Ms. “XXX Hanako” belongs to the “YYY Fourth Department”, and it also manages, as information, the fact that the “XXX First Department” is an organization higher in ranking than the “YYY Fourth Department” in the departmental organization system. From these, it is possible for the attribute relation setting section 23A to make a determination that there is a relation “The matter decided or resolved and the documents created in the “XXX First Department” are referenced by the “YYY Fourth Department””.

(Step S45: Acquisition of User-Related Information)

When it is determined that the external attribute management section 24 performs the management of inquiries, the attribute relation setting section 23A acquires, from the external attribute management section 24, the user-related information derived from the relation of dependence between the groups. For example, a relation “Mr. “XXX Tarou” is referenced by Ms. “XXX Hanako”.” is acquired together with a relation “The “XXX First Department” is a group referenced by the “YYY Fourth Department””.

(Step S46: Transmission to the Attribute-Related Information Management Section)

The attribute relation setting section 23A transmits the above acquired relations to the attribute-related information management section 22.

(Step S47: Setting)

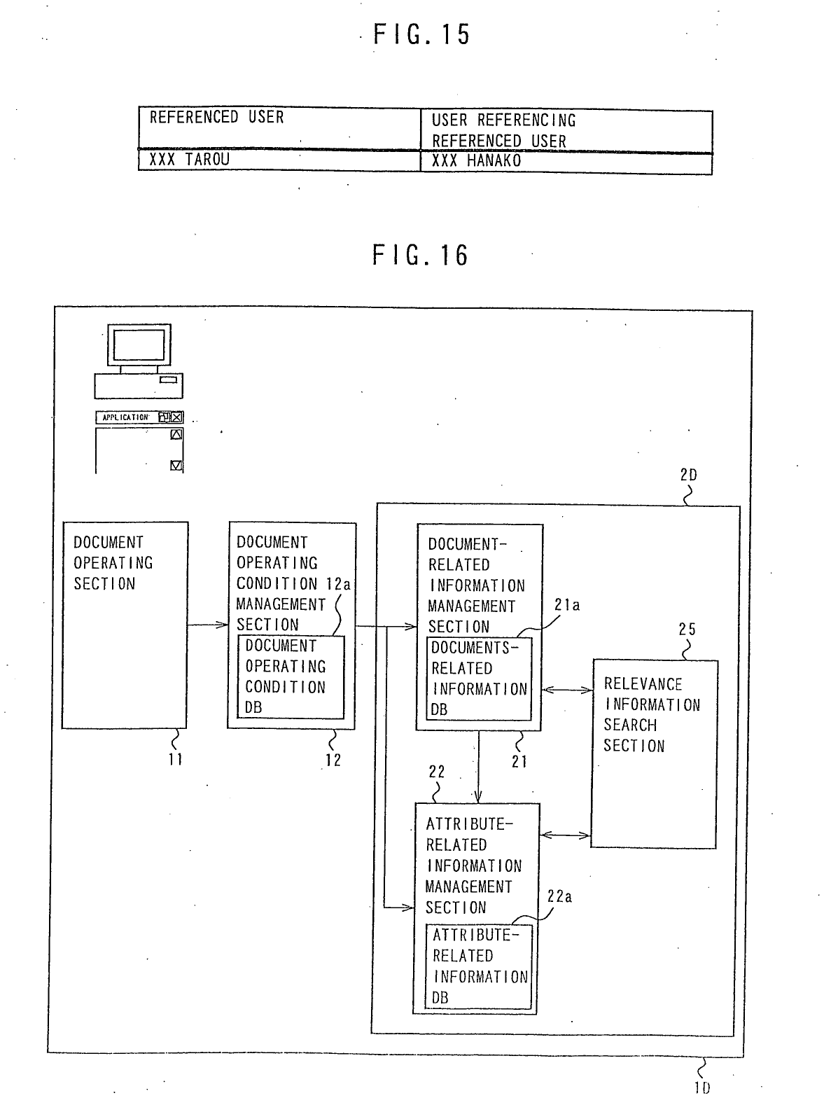

The attribute-related information management section 22 stores the relations transmitted from the attribute relation setting section 23A in the attribute-related information database 22a as a table shown in FIG. 15.

(Step S48: Completion)

When no inquiries are managed in the external attribute management section 24 in step S44, the processing is completed as it is.

Here, it is needless to say that when no inquiries are managed in the external attribute management section 24, the processing may automatically be shifted to the case of the Acquisition of Attribute-Related Information (Example 3).

<Search>

In the past, an application was provided for searching and displaying documents related to a document that is now being operated on a desktop of an operating system (OS) for example by making use of document relation, so that the documents, which were thus searched and seemed to be relevant to the user's business, were presented to the user. Here, reference will be further made to a device which can search for the values of attributes with a search key being provided by a user to present the result of the search to the user while making use of the relevance between the attributes of documents.

FIG. 16 illustrates a device that further includes a relevance information search section 25 added to the device or system shown in FIG. 1. This relevance information search section 25 can search for not only the relevance or relation between documents but also the relevance or relation between the attributes of the documents. Here, by providing a search key, the relevance information search section 25 serves to make it possible to search for relevant or related document information through document-related information and attribute-related information, and it is constituted, for example, by a software module that is provided with a user interface capable of automatically issuing queries to the databases in accordance with user's purposes and presenting the results of the queries to the user.

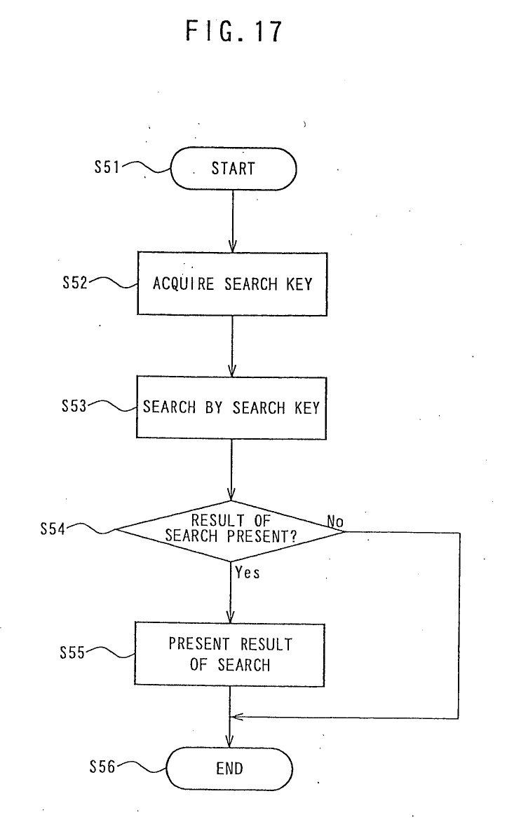

Hereinafter, reference will be made to such a search operation while referring to a flow chart in FIG. 17.

(Step S51: Start)

A search for relevance of document attributes is started by using the attribute-related information acquired by the above-mentioned Acquisitions of Attribute-Related Information (Examples 1 through 4).

(Step S52: Acquisition of a Search Key)

The relevance information search section 25 acquires from a user a key which becomes a search condition.

(Step S53: Search by a Search Key)

The relevance information search section 25 selects, based on the search condition, an attribute-related information table that becomes a target to be searched and is stored in the attribute-related information database 22, and performs a search by designating the search key.

For example, a search can be made for a user's request “Which creation application is used to create a document while referencing the documents of a “Word Processor” ?”. In addition, a search can also be made by combining, in a variety of ways, a plurality of pieces of attribute information that are managed in the attribute-related information management section.

For example, a search can be made for a user's request of searching for “What is the documents that were created by the use of a “Creation Application” referencing documents of a “Word Processor” and that were created by a “Creator” referencing “XXX Tarou”?”.

(Step S54: Determination of the Presence or Absence of the Search Result)

It is determined whether a search has been performed.

(Step S55: Presentation of the Search Result)

When a search has been performed, the relevance information search section 25 makes a presentation of the result of the search.

(Step S56: Completion)

The search result is displayed, and the processing is completed. Here, note that when a search has not been performed in the determination of step S54, the processing is completed as it is.

<Ranking of Documents>

Hereinafter, reference will be made to a document information management device that can rank important ones from among the documents being managed.

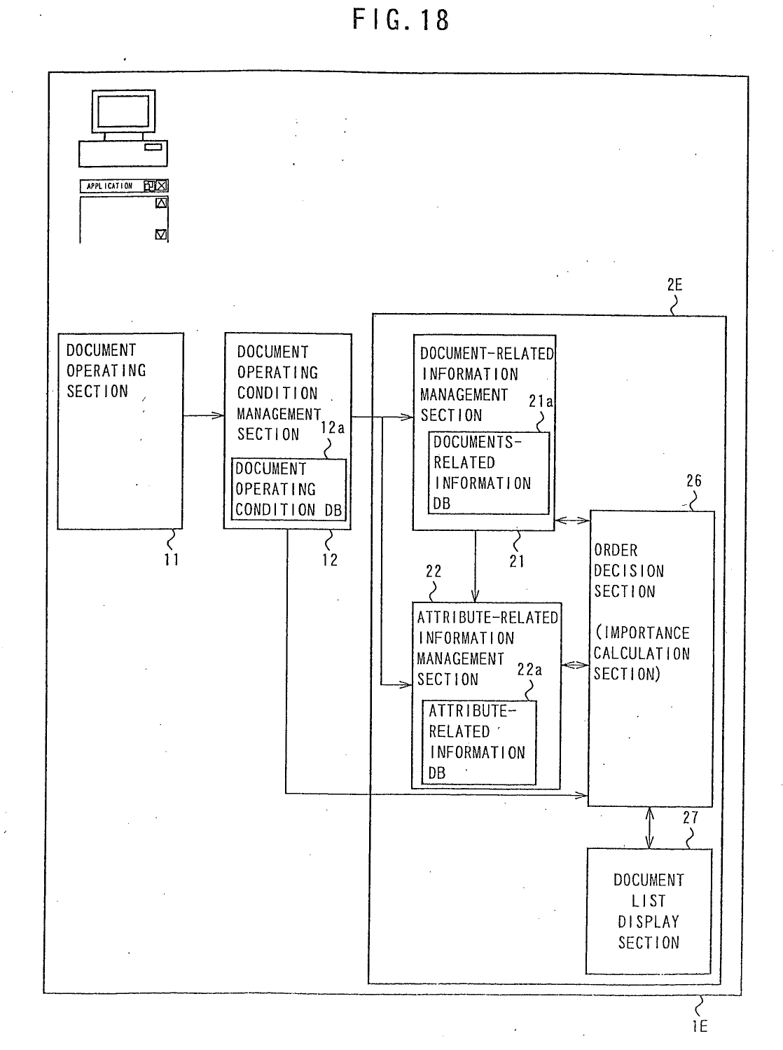

As shown in FIG. 18, this document information management device 2E includes an order decision section (importance calculation section) 26 that calculates and ranks an importance of each document based on the document-related information accumulated in the document-related information database 21a and the attribute-related information accumulated in the attribute-related information database 22a, and a document list display section 27 that is provided with a user interface capable of displaying a list of documents in the order of importance of the documents ranked by the order decision section 26. Here, note that the order decision section 26 and the document list display section 27 can be constituted by software modules, respectively.

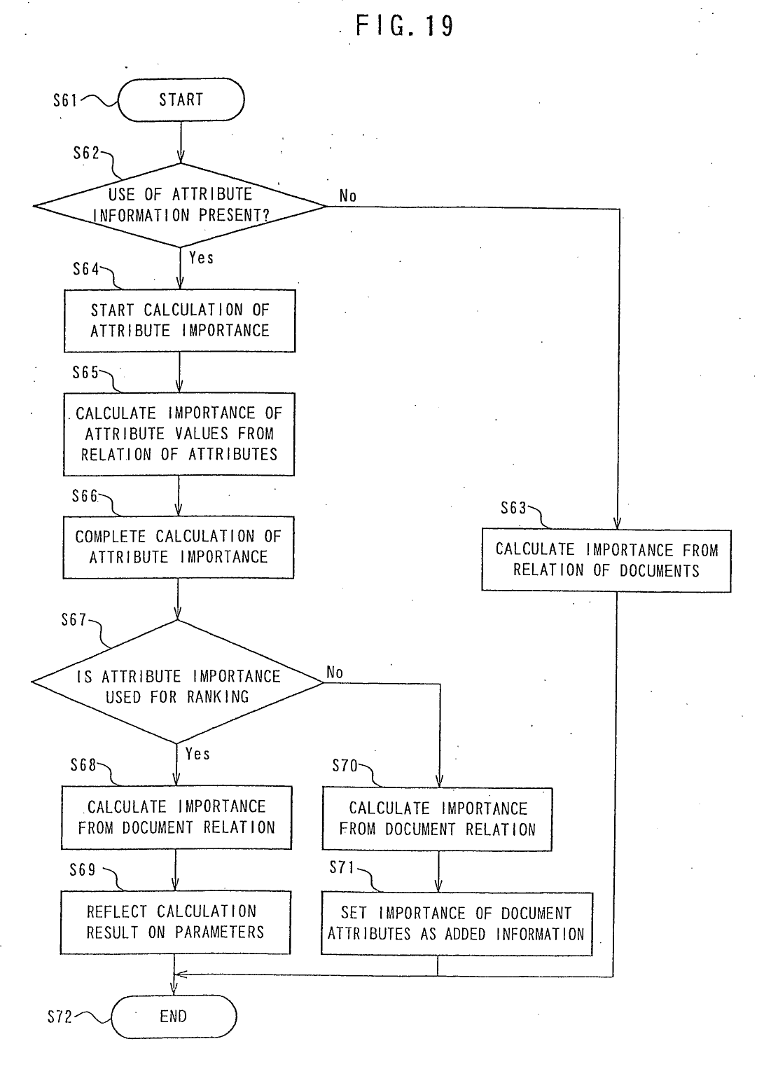

Next, reference will be made to the ranking operation by using a flow chart in FIG. 19.

(Step S61: Start)

The processing of ranking the documents to be searched is started.

(Step S62: Determination of the Presence or Absence of the Use of Attribute Information)

First of all, when documents are ranked, a selection is made as to whether the information of relevance or relation between the attributes of the documents is made use of. For this, a ranking method can be decided in advance as a policy for the entire system 1E, or a ranking method can be set by the user according to the user's purpose when the result of ranking is necessary.

(Step S63: Calculation of Importance from Document Relevance or Relation)

If the information of relevance or relation between the attributes of documents is not made use of, the importance of the documents is calculated and ranked only from the relevance or relation information of the documents.

The calculation of the document importance is carried out by arranging all the mutually relevant or related documents and modeling documents with reference relation (referencing or referenced) as a directed graph with the heads of arrows being pointed from referencing documents to their referenced documents.

A rank calculation method similar to the page ranking technique of calculating the importance of web pages disclosed in U.S. Pat. No. 6,285,999B1 is adopted, but parameters ((1) the number of links being linked, (2) the degree of recommendation of each linked page, and (3) the number of links of each linked page) used in that page ranking technique are properly adapted or replaced in the following manner for use with the present rink calculation method.

(1) The number of links being linked is replaced with the number of documents derived from a document to be referenced.

(2) The degree of recommendation of each linked page is replaced with an importance of each document derived from a document to be referenced.

(3) The number of links of each linked page is replaced with the number of documents referencing each document derived from a document to be referenced.

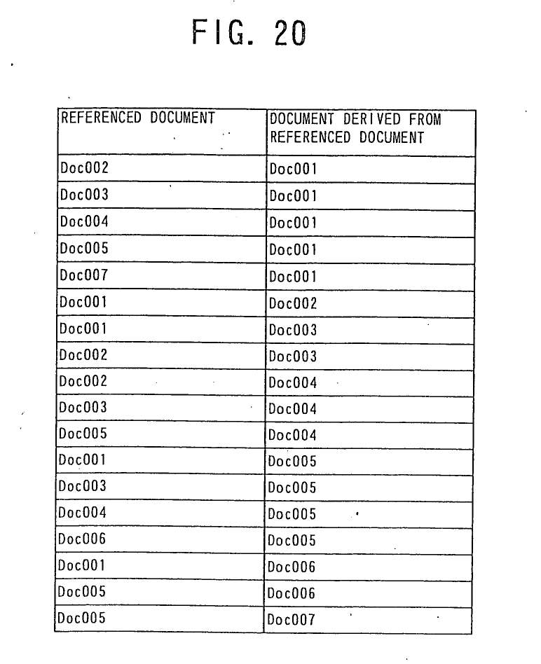

For example, when referenced documents and the documents derived from the referenced documents are related with one another as shown in FIG. 20, the importance of each document according to the page ranking technique is as follows.
Doc001: 0.304
Doc002: 0.166
Doc003: 0.141
Doc004: 0.105
Doc005: 0.179
Doc006: 0.045
Doc007: 0.061

(Steps S64 through S66: Calculation of Attribute Importance)

If the relevance or relation information of attributes is made use of, an importance of the value of each pertinent attribute has to be calculated for each of the kinds of attributes to be searched. For the attributes to be searched, there can be adopted a method of deciding the attributes to be searched in advance as a policy for the entire device, or a method in which the user sets the attributes to be searched according to the user's purpose when requiring the result of ranking.

For each attribute, the importance thereof is calculated by making use of the relevance or relation information of the attributes already obtained in the above-mentioned Acquisitions of Attribute-Related Information (Examples 1 through 4). This can be calculated by making use of the derivation relevance or relation in the value of each attribute to be searched, etc., as in the method of calculating the importance from the document relevance or relation as described in step S71.

(Step S67: Determination as to Whether Attribute Importance is Used for Ranking)

Then, it is determined whether the importance of each of the attributes of documents is used as a parameter for ranking the documents. That is, a selection is made as to whether the importance of each attribute as stated above is utilized as a parameter for calculating the importance of each document. For this, there can be adopted a method of deciding whether to use the attributes of documents for calculation of the importance of the documents in advance as a policy for the entire device, or a method in which the user sets whether to use the attributes of documents for calculation of the importance of the documents according to the user's purpose when requiring the result of ranking.

(Step S68: Calculation of Importance from the Document Relation)

In the case of utilizing the importance of each attribute, the value of the importance is reflected on a parameter used in calculating the importance of each document from the relevance or relation thereof. Here, the importance of documents is once calculated only from the relevance or relation between the documents according to a method of not reflecting the importance of attributes.

(Step S69: Reflection on Parameters)

Then, the importance of attributes carried or possessed by each document is taken into consideration. First, the importance of each document is calculated according to a calculation method similar to that of step S63. Then, the importance calculated for the value of each attribute of a document is added to the importance of the document. In this case, attributes whose importance is to be added and amounts of distribution of such additions among the attributes can be newly selected again.

For these, there can be adopted a method of deciding these items (the attributes to be added and the amounts of distribution of additions) in advance as a policy for the entire device, or a method in which the user sets these items according to the user's purpose when requiring the result of ranking. For example, the amounts of distribution of additions can be set in such a manner that for the importance of a document being 10, the importance of an attribute “Creator” is 6, and the importance of an attribute “Creation Application” is 4, with a total distribution being 20. In this case, let us assume that the importance of a document “Patent.doc” is 5 points, the importance of “XXX Tarou”, who is the creator of that document, is 3 points, and the importance of a “Word Processor”, which is the creation application of that document, is 2 points. Then, the importance of the document “Patent.doc” can be calculated as (10/20)*5+(6/20)*3+(4/20)*2=3.8.

In addition, instead of such a method, it is also possible to adopt, upon calculation of the importance of documents, a method for reflecting the importance of attributes of the documents as parameters from the beginning. This method can be adopted as a policy for the entire system or it can be set by the user according to the user's purpose when the user needs the result of ranking.

(Step S70: Calculation of Importance from Document Relation)

In the case of not utilizing the importance of attributes of documents, the importance of the documents is first calculated only from the relevance or relation of the documents.

(Step S71: Setting of the Importance of the Attributes of Documents as Added Information)

Although the ranking of documents itself is performed based solely on the importance obtained in step S70, the importance of the attributes of the documents is set to the documents as added information. By doing so, when a list of the documents is displayed in a ranking according to the document importance by the document list display section 27, it becomes possible to sort the documents in a ranking according to the importance of the attributes. Accordingly, it is possible to provide a user interface capable of performing the sorting of the documents according to the importance of their attributes that are designated by the user.

(Step S72: Completion)

The calculation of the importance as described above can be performed at the same timing as the processing of extracting the relevance or relation of documents, whereby even if a new relation is extracted, the importance corresponding to the new relation can be immediately calculated, thus making it possible to perform more adequate or appropriate ranking.

Moreover, ranking has not to be performed in advance, but it is possible to carry out ranking according to user's purposes at the time when a request is made by a user. By doing so, the user can avoid wasting the processing time for calculating the importance of unnecessary attributes as well as resources for managing information.

<Addition of an Information Search Section>

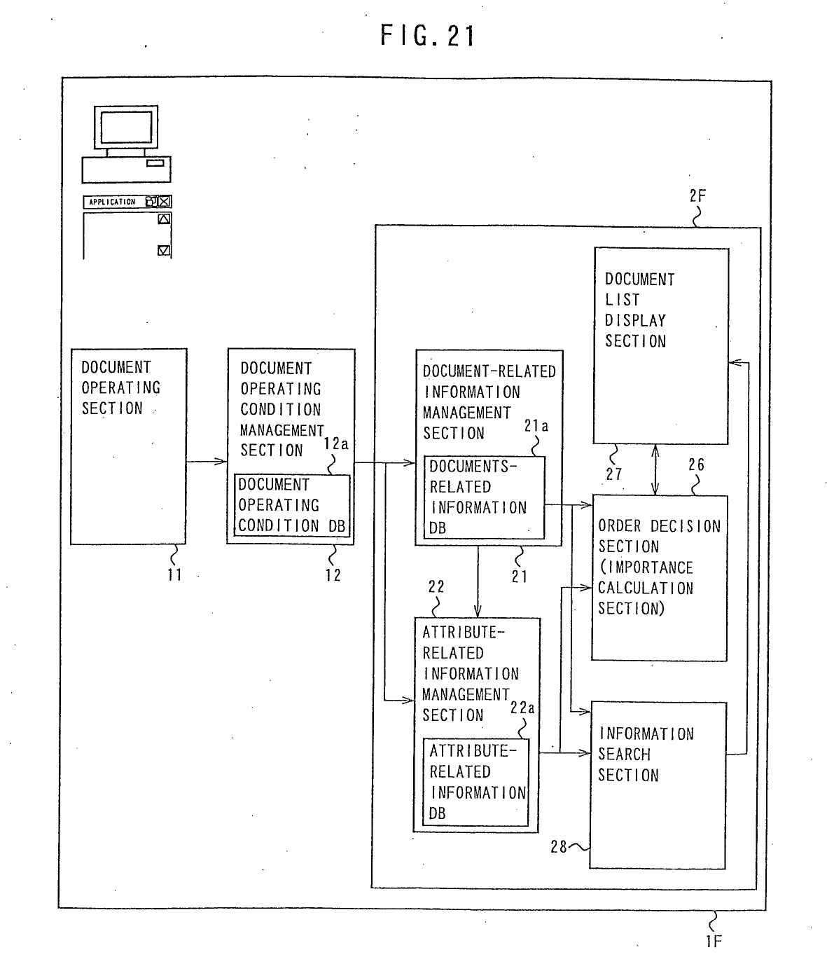

FIG. 21 shows that an information search section 28 capable of performing information search is added to the document information management device that is able to carry out ranking, as explained in FIG. 18. In the information search section 28, it is possible to perform relevance or relation search in the relevance information search section 25 as shown in FIG. 16, full-text search by keywords and/or search by attributes.

When the result of such a search is passed to the document list display section 27, a list of the searched documents is displayed in a manner as sorted according to the ranking calculated by the order decision section 26. As a result, it becomes possible to narrow the result of an ordinary full-text search or the search result obtained by a document relation according to the user's search purpose in a more efficient and appropriate manner.

Although the preferred embodiment of the present invention has been described above, the above-mentioned embodiment is merely one form of the invention for realizing the present invention, the configuration thereof should not be limited in any manner within the scope of the invention as far as not departing from the gist or concept of the invention, but can be modified, varied or changed in any appropriate manner. Moreover, in the embodiment of the present invention, programs for realizing the functions implementing the present invention are recorded or stored in the interior of the device or system, but the present invention is not limited to this but similar functions or programs can be downloaded into the device or system via a network. Alternatively, a computer-readable recording medium storing therein similar functions or programs can be installed in the device or system.

The recording medium can be of any form, such as for example a CD-ROM, which is able to store programs and which is able to be read out by the device. In addition, the functions to be obtained by such preinstallation or downloading can be achieved through cooperation with an OS (operating system) or the like in the interior of the device.

1. A document information management device for managing document information, comprising:
a document-related information management section that analyzes, acquires and manages relevance information between documents as said document information; and
an attribute-related information management section that analyzes, acquires and manages relevance information between attributes of said documents as said document information.

2. The document information management device as set forth in claim 1, wherein said document-related information management section acquires a document operating condition, and analyzes and acquires document-related information based on said document operating condition.

3. The document information management device as set forth in claim 1, wherein said attribute-related information management section analyzes and acquires said attribute-related information based on said document-related information acquired by said document-related information management section.

4. The document information management device as set forth in claim 1, wherein said attribute-related information management section includes a relevance-strength time-related change setting section that is able to variably set the strength of attribute relevance in the acquired attribute-related information in a time-related manner.

5. The document information management device as set forth in claim 1, further comprising:
a first attribute-related information setting section that presents a predetermined attribute to a user for setting so as to permit the user to set attribute relevance which is to be managed by said attribute-related information management section.

6. The document information management device as set forth in claim 1, further comprising:
a second attribute-related information setting section that accesses an outside attribute management section managing attributes through a communication line to acquire an attribute, and sets the attribute relevance managed by said attribute-related information management section into said attribute-related information management section based on said attribute thus acquired.

7. The document information management device as set forth in claim 1, further comprising:
a relevance information search section that searches for other attributes related to a prescribed attribute by using said prescribed attribute as a key.

8. A document information management device for managing document information, comprising:
a document-related information management section that analyzes, acquires and manages relevance information between documents as said document information;
an attribute-related information management section that analyzes, acquires and manages relevance information between attributes of documents as said document information; and
an order decision section that decides the order of presentation of searched documents by using at least either one of said document-related information and said attribute-related information.

9. The document information management device as set forth in claim 8, wherein when deciding the order of presentation of searched documents by using said attribute-related information, said order decision section calculates an importance of each attribute value based on a plurality of pieces of attribute-related information and decides the order of said documents by using the importance values thus calculated.

10. A document information management program for making a computer execute document information management to manage document information,
said document information management program adapted to make said computer perform:
a document-related information acquisition step for analyzing and acquiring relevance information between documents as said document information; and
an attribute-related information acquisition step for analyzing and acquiring relevance information between attributes of said documents as said document information.

11. The document information management program as set forth in claim 10, wherein in said document-related information acquisition step, said computer is made to acquire a document operating condition, and analyze and acquire document-related information based on said document operating condition.

12. The document information management program as set forth in claim 10, wherein in said attribute-related information acquisition step, said computer is made to analyze and acquire said attribute-related information based on the document-related information acquired in said document-related information acquisition step.

13. The document information management program as set forth in claim 10, further including:
a time-related change setting step which is executed by said computer to be able to variably set the strength of attribute relevance acquired in said attribute-related information acquisition step in a time-related manner.

14. The document information management program as set forth in claim 10, wherein said attribute-related information acquisition step includes a step that is executed by said computer to present a prescribed attribute to a user so as to permit a user to set attribute-related information to be acquired.

15. The document information management program as set forth in claim 10, wherein said attribute-related information acquisition step includes a step that is executed by said computer to make access to an outside attribute management section managing attributes through a communication line to acquire an attribute, so that said attribute-related information is acquired based on said attribute thus acquired.

16. The document information management program as set forth in claim 10, wherein said attribute-related information acquisition step includes a step that is executed by said computer to search for other attributes related to a prescribed attribute by using said prescribed attribute as a key.

17. A document information management program for making a computer execute document information management to manage document information,
said document information management program adapted to make said computer execute:
a document-related information acquisition step in which relevance information between documents is analyzed and acquired as said document information;
an attribute-related information acquisition step in which relevance information between attributes of said documents is analyzed and acquired as said document information; and
an order decision step in which the order of presentation of searched documents is decided by using at least either one of said document-related information and said attribute-related information.

18. The document information management program as set forth in claim 17, wherein said order decision step includes a step that is executed by said computer to calculate an importance of each attribute value based on a plurality of pieces of attribute-related information when the order of presentation of searched documents is decided by using said attribute-related information, so that the order of said documents is decided by using the importance values thus calculated.

19. A document information management method f or managing document information, comprising:
an operating condition acquisition step for acquiring a document operating condition;
a document-related information acquisition step for analyzing and acquiring relevance information between documents as said document information from said document operating condition; and
an attribute-related information acquisition step for analyzing and acquiring relevance information between attributes of said documents by using said relevance information between documents.

20. The document information management method as set forth in claim 19, further comprising:
an order decision step for deciding the order of presentation of searched documents by using at least either one of said relevance information between documents and said relevance information between attributes of said documents are.
